(19) United States
(12) Patent Application Publication
(10) Pub. No.: US 2002/0033926 A1
(43) Pub. Date: Mar. 21, 2002

(54) Manufacturing method of liquid crystal display

(76) Inventors: Hiroki Nakahara, Shiojiri-shi (JP); Shinji Hashikura, Matsumoto-shi (JP)

Correspondence Address: HARNESS, DICKEY & PIERCE, PLC, P.O. BOX 828, BLOOMFIELD HILLS, MI, 48303, US

(21) Appl. No.: 09/943,748

(22) Filed: Aug. 30, 2001

(30) Foreign Application Priority Data
Sep. 1, 2000 (JP) 2000-265594
Aug. 3, 2001 (JP) 2001-236576

(51) Int. Cl. G02F 1/1339

(52) U.S. Cl. 349/154; 349/189

(57) ABSTRACT

An uncured end-sealing material 50 is applied to each liquid crystal injection port 40a of a rectangular panel 40, a portion 50b of the end-sealing material 50 bleeding outside the contour of the rectangular panel 40 is removed by an absorbing method, a wiping method or a troweling method before the end-sealing material 50 cures, and then the end-sealing material 50 is allowed to cure.

### BACKGROUND OF THE INVENTION

1. Technical Field of the Invention

The present invention relates to a manufacturing method of a liquid crystal display, and more specifically, it relates to a method of sealing a liquid crystal.

2. Description of the Related Art

In a general manufacturing method of a liquid crystal display, a seal member is applied to one mother substrate (mother glass), and another mother substrate is joined by the seal member from the top of the seal member to form a mother panel having a plurality of liquid crystal sealing-in areas surrounded by the seal members. A rectangular panel referred to as a strip-like panel is manufactured by dividing the mother panel. Then, the liquid crystal is injected in each liquid crystal sealing-in area of the rectangular panel, an uncured end-sealing material is applied to a liquid crystal injection port, the end-sealing material cures to seal the liquid crystal, and the end-sealing material fixed to an outer surface of the rectangular panel is removed. Finally, the rectangular panel is divided into each liquid crystal sealing-in area to form a plurality of liquid crystal panels.

In the liquid crystal injecting and sealing steps in the above manufacturing method, first, each liquid crystal injection port of the rectangular panel is immersed in a liquid crystal sump in an evacuated chamber, and the pressure in the chamber is returned to the atmospheric pressure in this state to inject the liquid crystal in each liquid crystal sealing-in area of the rectangular panel. Next, the end-sealing material formed of ultraviolet radiation-curing type resin or the like is applied to each liquid crystal injection port using a dispenser or the like. The end-sealing material is irradiated with the ultraviolet radiation and photo-cured to seal the liquid crystal in the liquid crystal sealing-in areas.

However, in order to reliably seal the liquid crystal injection port formed in an end face of the rectangular panel, it is necessary to apply the end-sealing material in a quantity more than the minimum required for filling the liquid crystal injection port in order to prevent any sealing defects caused by any deviation from the line during application of the end-sealing material. As a result, excess end-sealing material projects from the end face of the rectangular panel after the end-sealing material cures. The excess end-sealing material overflows from the top end face of the rectangular panel, and can bleed over the front and back side edges of the panel. In this state, problems occur in that the rectangular panel is less easily positioned in the subsequent steps, it can be more difficult to bond a polarizer, and the end-sealing material can be brought into contact with a case body that accommodates the liquid crystal panel.

In particular, in a recent low profile liquid crystal panel using an extremely thin glass substrate having a thickness of 0.3 mm to 0.5 mm, the liquid crystal injection port is less easily observed by the refraction or scattering of light at the substrate edge, it is difficult to reduce the quantity of the end-sealing material, the height of the bleeding end-sealing material over the end face is increased due to the reduced thickness of the substrate, the quantity of the end-sealing material bleeding over the front and back side edges of the panel is increased, and as a result, the above problems become more conspicuous.

In order to solve the above problems as shown in FIG. 8, a end-sealing material 50 is applied to a rectangular panel 40 comprising substrates 46, 48 bonded to each other by a seal member 22, and after the end-sealing material 50 cures, a portion 50b of the end-sealing material 50 bleeding outside the contour of the panel is planed off by a planing member 60 such as a razor. However, in this method, a troublesome work of planing off the bleeding portion 50b of the cured end-sealing material is required, the working efficiency is degraded, a blade tip of the planing member 60 is brought into contact with end faces of the glass substrates 46, 48 in planing off the cured end-sealing material, microcracks can be formed thereby in the glass substrates 46, 48, and a problem occurs in that the shock resistance of a liquid crystal panel 60 is degraded by the presence of the microcracks. This problem is serious in the liquid crystal panel using a thin and less rigid substrate as described above.

Accordingly, the present invention has been made in light of the above problems, and an object of the present invention is to provide a manufacturing method of a liquid crystal panel to reduce the quantity of the end-sealing material bleeding outside the contour of the liquid crystal panel without degrading the shock resistance of the liquid crystal panel by improving a liquid crystal sealing step of the liquid crystal display.

### SUMMARY OF THE INVENTION

In order to solve the above problems, the manufacturing method of the liquid crystal display in accordance with the present invention comprises a liquid crystal injecting step of injecting the liquid crystal from a liquid crystal injection port in the liquid crystal sealing-in areas inside a liquid crystal panel, an end-sealing material applying step of applying an uncured end-sealing material to the liquid crystal injection port after the liquid crystal is injected, an end-sealing material removing step of absorbing at least a part of the end-sealing material bleeding outside the contour of the liquid crystal panel, and an end-sealing material curing step of curing the end-sealing material after the end-sealing material removing step.

In the above method, the uncured end-sealing material is applied to the liquid crystal injection port after the liquid crystal is injected from the liquid crystal injection port. Out of the applied end-sealing material, at least a part of the end-sealing material bleeding outside the contour of the liquid crystal panel is absorbed, and the end-sealing material is allowed to cure to complete the sealing of the liquid crystal panel.

The curing characteristic of the end-sealing material is arbitrary, and the end-sealing material may be, for example, an ultraviolet radiation curing type resin or a heat-curing-type resin.

In an embodiment of the above manufacturing method of the liquid crystal display, the end-sealing material can be absorbed by bringing an absorbent material into contact with the end-sealing material, and absorbing the end-sealing material by the absorbent material in the end-sealing material removing step.

In this embodiment, excess end-sealing material can be removed by the absorbing force of the absorbent material without applying any load to the liquid crystal panel side. The absorbent material is not limited thereto so long as it can absorb the uncured end-sealing material, and for example, the absorbent material includes paper, cotton cloth, non-woven fabric, and sponge.

In another embodiment of the above manufacturing method of the liquid crystal display, the end-sealing material can be removed by bringing a suction jig into contact with the end-sealing material and sucking the end-sealing material inside the suction jig in the end-sealing material removing step.

In this embodiment, the end-sealing material can be efficiently removed by the suction force of the suction jig even when the quantity of excess end-sealing material is relatively large.

In a still another embodiment of the above manufacturing method of the liquid crystal display, the end-sealing material removing step further comprises a step of troweling off the end-sealing material along an end face of the liquid crystal panel where the liquid crystal injection port is arranged by a troweling jig after the above end-sealing material sucking step by the suction jig.

In this embodiment, after excess end-sealing material is removed, the end-sealing material is further troweled off over the end face of the liquid crystal panel by the troweling jig, and allowed to cure, and as a result, the end face of the liquid crystal panel is flattened to prevent troubles in the subsequent assembly of the liquid crystal panel.

A still another embodiment of the above manufacturing method of the liquid crystal display further comprises a step of increasing the pressure inside the liquid crystal sealing-in areas of the liquid crystal panel before the liquid crystal injecting step and a step of evacuating the liquid crystal sealing-in areas after the end-sealing material applying step and before the end-sealing material removing step.

In this embodiment, the end-sealing material is injected into a vicinity of the liquid crystal injection port by increasing the pressure in the liquid crystal sealing-in areas before injecting the liquid crystal, and evacuating the liquid crystal sealing-in areas after the end-sealing material is applied. As a result, the end-sealing material is allowed to cure, and the liquid crystal injection port can be reliably filled.

Another manufacturing method of the liquid crystal display in accordance with the present invention comprises a liquid crystal injecting step of injecting the liquid crystal from the liquid crystal injection port into the liquid crystal sealing-in areas inside the liquid crystal panel, an end-sealing material applying step of applying the uncured end-sealing material to the liquid crystal injection port after the liquid crystal is injected, a wiping step of wiping at least a part of the end-sealing material bleeding outside the contour of the liquid crystal panel by a wiping jig, and an end-sealing material curing step of curing the end-sealing material after the wiping step.

In the above method, the uncured end-sealing material is applied to the liquid crystal injection port after the liquid crystal is injected from the liquid crystal injection port. At least a part of the end-sealing material bleeding outside the contour of the liquid crystal panel of the applied end-sealing material is wiped using the wiping tool, and the end-sealing material is allowed to cure to complete the sealing of the liquid crystal panel.

An embodiment of the above manufacturing method of the liquid crystal display further comprises a step of increasing the pressure inside the liquid crystal sealing-in areas of the liquid crystal panel before the liquid crystal injecting step and a step of evacuating the liquid crystal sealing-in areas after the end-sealing material applying step and before the end-sealing material wiping step.

In this embodiment, the end-sealing material is injected in a vicinity of the liquid crystal injection port by increasing the pressure in the liquid crystal sealing-in areas before injecting the liquid crystal, and evacuating the liquid crystal sealing-in areas after the end-sealing material is applied. As a result, the end-sealing material is allowed to cure, and the liquid crystal injection port can be reliably filled.

Still another manufacturing method of the liquid crystal display in accordance with the present invention comprises a liquid crystal injecting step of injecting the liquid crystal from the liquid crystal injection port into the liquid crystal sealing-in areas inside the liquid crystal panel, an end-sealing material applying step of applying the uncured end-sealing material to the liquid crystal injection port after the liquid crystal is injected, a troweling step of troweling off the end-sealing material bleeding outside the contour of the liquid crystal panel on an end face of the liquid crystal panel where the liquid crystal injection port is arranged by a troweling jig, and an end-sealing material curing step of curing the end-sealing material after the troweling step.

In the above method, the uncured end-sealing material is applied to the liquid crystal injection port after the liquid crystal is injected from the liquid crystal injection port. At least a part of the end-sealing material bleeding outside the contour of the liquid crystal panel of the applied end-sealing material is troweled using the troweling tool, and the end-sealing material is allowed to cure to complete the sealing of the liquid crystal panel.

An embodiment of the above manufacturing method of the liquid crystal display further comprises a step of increasing the pressure inside the liquid crystal sealing-in areas of the liquid crystal panel before the liquid crystal injecting step and a step of evacuating the liquid crystal sealing-in areas after the end-sealing material applying step and before the end-sealing material troweling step.

In this embodiment, the end-sealing material is injected into the liquid crystal injection port from the liquid crystal injection port by increasing the pressure in the liquid crystal sealing-in areas before injecting the liquid crystal, and evacuating the liquid crystal sealing-in areas after the end-sealing material is applied. As a result, the end-sealing material is allowed to cure, and the liquid crystal injection port can be reliably filled.

In a liquid crystal display having a liquid crystal panel with a liquid crystal sealed in liquid crystal sealing-in areas disposed between a pair of substrates, the liquid crystal panel is manufactured by injecting the liquid crystal from liquid crystal injection port into the liquid crystal sealing-in areas, applying an uncured end-sealing material to the liquid crystal injection port after injecting the liquid crystal, sucking at least a part of the end-sealing material bleeding outside the contour of the liquid crystal panel, and then, curing the end-sealing material.

In another liquid crystal display having a liquid crystal panel with a liquid crystal sealed in liquid crystal sealing-in areas disposed between a pair of substrates, the liquid crystal panel is manufactured by injecting the liquid crystal from a liquid crystal injection port into the liquid crystal sealing-in areas, applying an uncured end-sealing material to the liquid crystal injection port after injecting the liquid crystal, wiping at least a part of the end-sealing material bleeding outside the contour of the liquid crystal panel by a wiping jig, and then, curing the end-sealing material.

In another liquid crystal display having a liquid crystal panel with a liquid crystal sealed in liquid crystal sealing-in areas disposed between a pair of substrates, the liquid crystal panel is manufactured by injecting the liquid crystal from liquid crystal injection port into the liquid crystal sealing-in areas, applying an uncured end-sealing material to the liquid crystal injection port after injecting the liquid crystal, troweling the end-sealing material bleeding outside the contour of the liquid crystal panel on an end face of the liquid crystal panel having the liquid crystal injection port by a troweling jig, and then, curing the end-sealing material.

In the above liquid crystal display, the portion bleeding outside the contour of the liquid crystal panel of the end-sealing material applied to the liquid crystal injection port is removed by a method of absorbing, wiping, troweling, etc., and troubles can be prevented in that the portion bleeding outside the contour of the liquid crystal panel cures as it is, and does not cause an obstacle in the subsequent manufacturing steps.

### BRIEF DESCRIPTION OF THE DRAWINGS

FIG. 1 is a schematic plan view of a mother panel formed by a manufacturing method of a liquid crystal display and having a plurality of liquid crystal sealing areas insidetherein.

FIG. 2 is a schematic plan view of a rectangular panel formed by dividing the mother panel into a rectangular shape in the manufacturing method of the liquid crystal display.

FIGS. 3(a) to 3(d) are schematic longitudinal sectional views and partial plan views of the rectangular panel to show the status of the rectangular panel in each stage of a liquid crystal sealing step in an embodiment of the manufacturing method of the liquid crystal display in accordance with the present invention.

FIG. 4 is a schematic perspective view schematically showing the liquid crystal sealing step by one method, and a condition of removing an uncured endsealing material from the rectangular panel.

FIG. 5 is a schematic perspective view showing a schematic representation of the liquid crystal sealing step by another method, and a condition of removing an uncured end-sealing material from the rectangular panel.

FIG. 6 is a flowchart showing the manufacturing method of the liquid crystal display including the liquid crystal sealing step in accordance with the present invention.

FIG. 7 is a flowchart showing the details of the liquid crystal sealing step in the manufacturing method of the liquid crystal display shown in FIG. 6.

FIG. 8 is a flowchart of a conventional liquid crystal sealing step, and a schematic perspective view schematically showing the condition that a cured end-sealing material is removed from the rectangular panel.

### DETAILED DESCRIPTION OF THE PREFERRED EMBODIMENTS

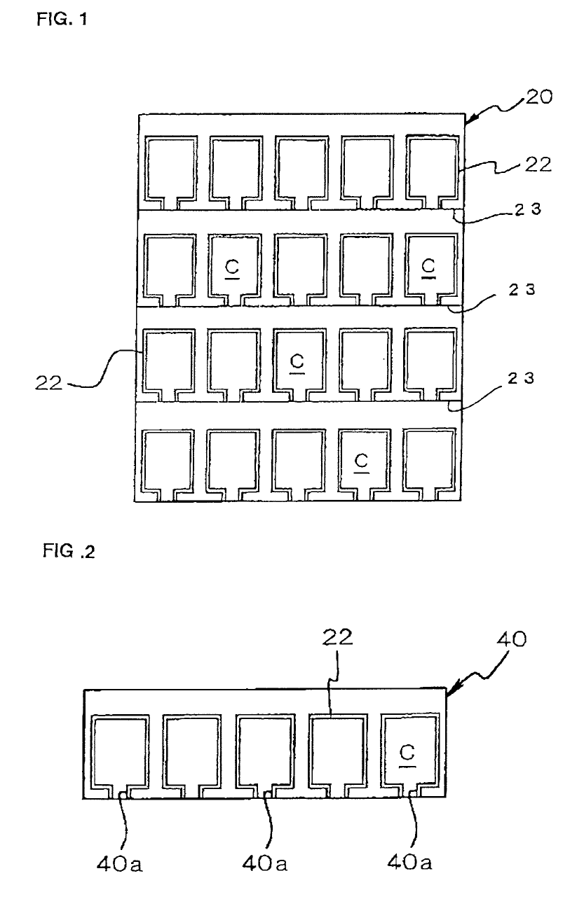

Next, an embodiment of a manufacturing method of a liquid crystal display in accordance with the present invention will be described in detail with reference to the attached drawings. FIG. 1 is a schematic plan view of a mother panel 20 holding seal members 22 between a pair of mother substrates formed of glass or the like.

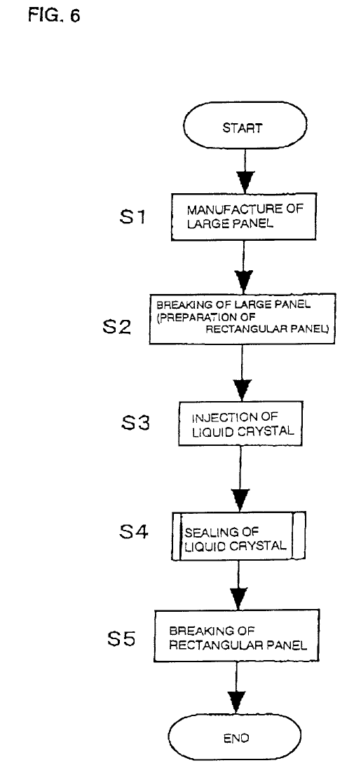

First, the outline of the manufacturing method of the liquid crystal display will be described with reference to a flowchart in FIG. 6. As shown in FIG. 1, a seal member 22 is bonded to one mother substrate, and the other mother substrate is bonded on the seal member 22 to form a mother panel 20 having a plurality of liquid crystal sealing areas C surrounded by the seal members 22 (Step S1). Next, the mother panel 20 is broken along a breaking line 23 indicated by broken lines in FIG. 1, and a rectangular panel 40 (which is also referred to as a “strip-like panel”) shown in FIG. 2 is formed(Step S2).

Next, the liquid crystal is injected in each liquid crystal sealing-in area C of the rectangular panel 40 (Step S3), an uncured end-sealing material is applied to liquid crystal injection port 40a, the end-sealing material on an outer surface of the rectangular panel 40 is removed before the end-sealing material cures, and the end-sealing material is allowed to cure (Step S4). Finally, the rectangular panel 40 is broken into each liquid crystal sealing-in area C to form a liquid crystal panel (Step S5).

In the liquid crystal sealing step S4 of the present invention, the end-sealing material bleeding outside the contour of the liquid crystal panel is removed or reduced in quantity by an absorbing method, a wiping method, a troweling method, etc. Each of the above steps will be successively described in detail.

The mother panel manufacturing step S1 is implemented as follows. First, a transparent electrode is formed of ITO (Indium Tin Oxide: indium-tin alloy oxide film) by a sputtering method, etc. on one side of the mother substrate, and a protective film formed of SiO₂ (silicon dioxide) and an alignment layer formed of a polyimide resin are laminated thereon. Then, the seal member 22 formed of an epoxy resin, etc. is bonded by a dispenser, a printing method, etc. Another mother substrate is bonded on the seal member 22 so that transparent electrode patterns correspond to each other, and then, the seal member 22 cures. The seal member 22 demarcates a plurality of arrayed liquid crystal sealing-in areas C in the mother panel.

Next, in the mother panel dividing step S2, the mother panel 20 is broken into rectangular shapes to form the rectangular panel 40 shown in FIG. 2. A plurality of the liquid crystal sealing-in areas C are arranged in a row in the rectangular panel 40, and a plurality of liquid crystal injection ports, 40a are exposed along one end face of the rectangular panel 40, i.e., an end face corresponding to the breaking line 23 of the mother panel.

Next, in the liquid crystal injecting step S3, a liquid crystal 42 is injected from the liquid crystal injection port 40a making use of the difference between the internal pressure and the external pressure in each liquid crystal sealing-in area C of the rectangular panel 40. More specifically, each liquid crystal injection port 40a of the rectangular panel 40 is immersed in the liquid crystal stored in a liquid crystal sump in an evacuated chamber, and the liquid crystal is injected in each liquid crystal sealing-in area C of the rectangular panel 40 by returning the pressure in the chamber to the atmospheric pressure in this state.

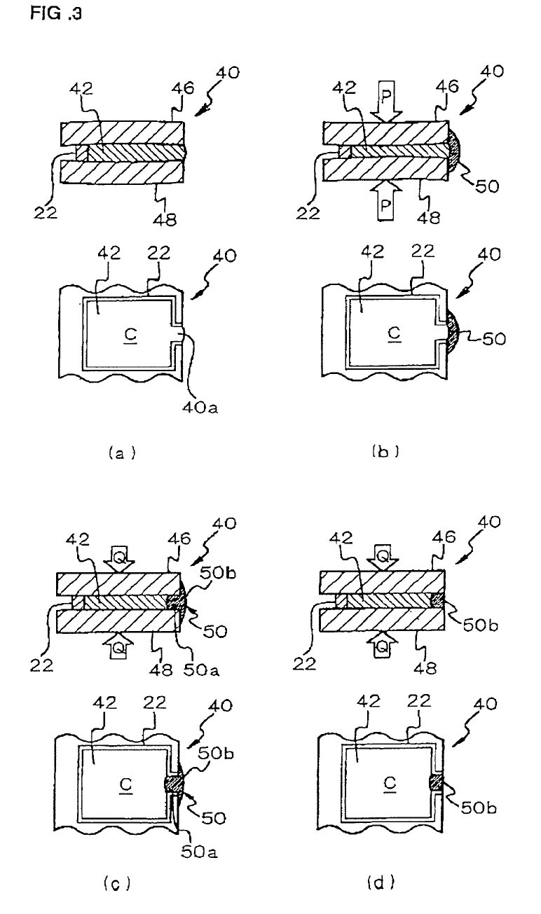

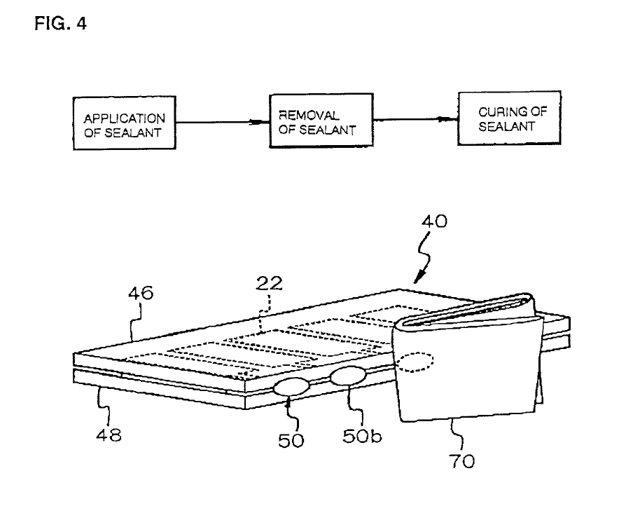

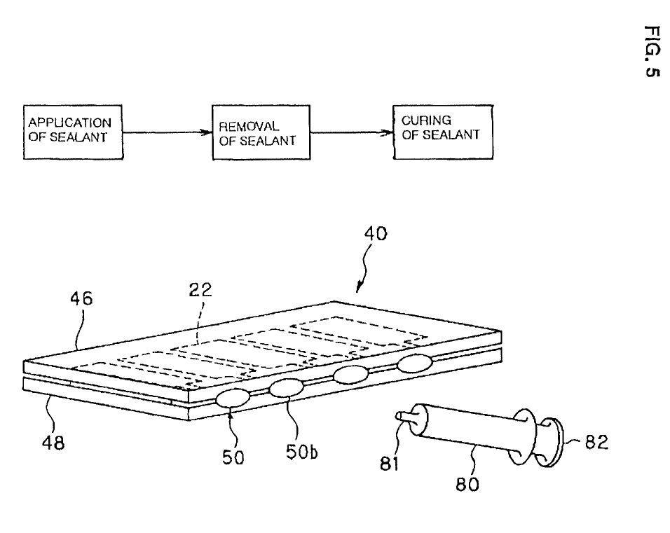

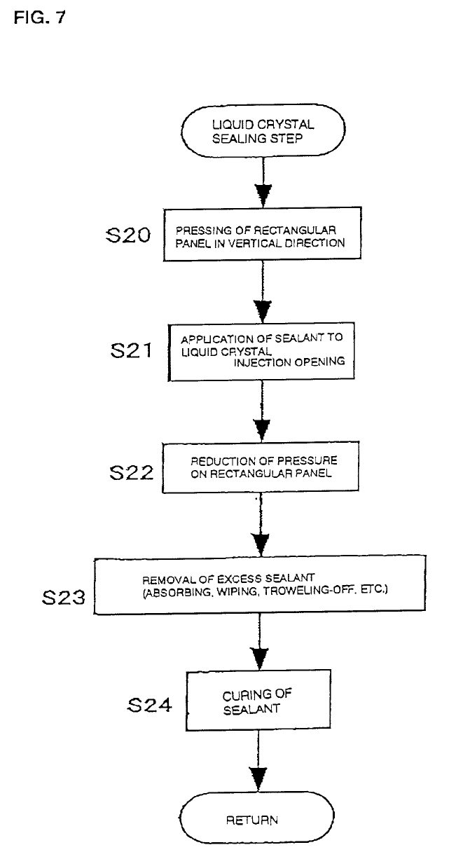

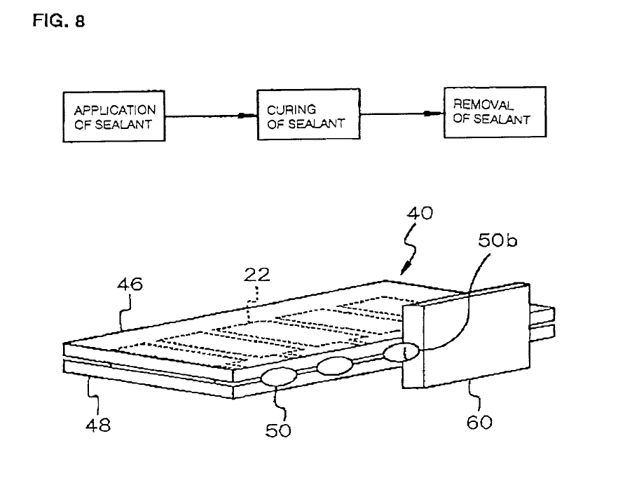

Next, the liquid crystal sealing step S4 of the present embodiment will be described with reference to FIGS. 3 to 5, and FIG. 7. FIGS. 3(a) to 3(d) show a longitudinal sectional view and a plan view of the above rectangular panel 40 for each step of the liquid crystal sealing step. FIG. 4(a) shows a schematic step of one end-sealing material removing method by the absorption, and FIG. 4(b) shows the schematic implementation of the method. FIG. 5(a) shows a schematic step of another end-sealing material removing method by absorption, and FIG. 5(b) shows the schematic implementation of the method. FIG. 7 is a flowchart showing the details of the liquid crystal sealing step S4.

As described above, in the rectangular panel 40 with the liquid crystal 42 injected in the liquid crystal sealing-in areas C, glass substrates 46, 48 are slightly deflected in an outwardly swollen shape in the beginning as shown in FIG. 3(a).

As shown in FIG. 3(b), in order to regulate the shape of the rectangular panel 40, the rectangular panel 40 is compressed by the pressure P (Step S20). In this compressed state, the space between substrates is regulated by a spacer not shown in the figure but generally disposed between the glass substrates 46, 48 in this compressed state, and the pressure inside the liquid crystal sealing-in areas is increased. In this state, an uncured end-sealing material 50 formed of ultraviolet radiation-curing type resin is applied to the liquid crystal injection port 40a (Step S21).

In this state, the liquid crystal injection ports 40a are opened in an end face of the rectangular panel 40. Since end faces of the glass substrates 46, 48 are observed white due to refraction and scattering of the light, the position of the liquid crystal injection port 40a is difficult to check. This phenomenon is particularly conspicuous when the glass substrates 46, 48 are formed of glass or plastic as thin as 0.3 to 0.5 mm. The position of application of the end-sealing material 50 is thus difficult to determine, and the end-sealing material 50 in a quantity considerably more than the minimum required for sealing the liquid crystal injection ports 40a is applied to the position in a vicinity of the liquid crystal injection ports 40a.

Next, as shown in FIG. 3(c), the pressure P compressing the rectangular panel 40 in the lamination direction is reduced to obtain about one half the pressure Q (Step S22). Since the internal pressure in the liquid crystal sealing-in areas of the rectangular panel 40 drops in this operation, a part 50a of the applied end-sealing material 50 is drawn into the liquid crystal injection ports 40a to reliably seal the liquid crystal injection ports 40a.

As described above, a large volume of the end-sealing material 50 is applied, and a part of the end-sealing material 50 bleeds outside the contour of the rectangular panel 40. The spread of the bleeding portion 50b corresponds to the quantity of the applied end-sealing material 50, and the bleeding height outward of the contour of the rectangular panel 40 (i.e., the projecting quantity from the position of the end faces of the glass substrates 46, 48 constituting the rectangular panel 40) also corresponds to the quantity of the applied end-sealing material 50. When the quantity of the applied end-sealing material 50 is large, this portion 50b not only bleeds outside the position of the end faces of the glass substrates 46, 48, but also possibly bleeds over external surfaces (front and rear sides of the rectangular panel 40) of the glass substrates 46, 48.

In the present embodiment, the rectangular panel 40 is compressed by the pressure Q which is about one half the pressure P, and the pressure may arbitrarily drop, and the condition can be appropriately set so that a desired cell thickness distribution is obtained in each liquid crystal sealing-in area of the rectangular panel 40. This means that, if the desired cell thickness distribution is obtained after the sealing, the pressure Q in this state may only be lower than the pressure P, and further, the pressure may be completely removed in this state.

Next, the bleeding portion of the end-sealing material on the end face of the rectangular panel 40 is removed by an absorbing method, a wiping method, a troweling method, etc. (Step S23). In one method, as shown in FIG. 4(b), a cotton cloth 70 is pressed against a vicinity of the liquid crystal injection ports 40a of the rectangular panel 40 to absorb the bleeding portion 50b of the end-sealing material 50 by the cotton cloth 70. In this state, the end-sealing material applied to a vicinity of the liquid crystal injection ports 40a does not yet cure, and is still fluid, and as a result, most of the bleeding portion 50b of the end-sealing material along the end face of the rectangular panel 40 can be removed. A material to absorb the bleeding portion 50b of the end-sealing material 50 is not limited to the cotton cloth 70, but any other materials which can absorb the uncured end-sealing material 50 may be applicable. For example, the material includes a nonwoven fabric, a paper, a sponge (including a sponge-like resin), etc.

In addition, the end-sealing material can be absorbed by a method shown in FIG. 5(b). In an example in FIG. 5(b), the end-sealing material bleeding over the end face of the rectangular panel 40 is absorbed and removed by using a suction syringe 80. This means that the bleeding end-sealing material 50 can be drawn into the suction syringe 80 by placing a forward end portion 81 of the suction syringe 80 on the bleeding portion 50b of the end-sealing material, and pulling a piston 82.

Further, at least a part of the bleeding portion of the end-sealing material outside the end face of the rectangular panel 40 may be removed not only by the above method of absorbing the bleeding portion 50b, but also by a method of adhering the end-sealing material to an appropriate member and removing it (i.e., wiping it). In this method, a wiping piece such as a cloth in place of the cotton cloth 70 in FIG. 4(b) is placed on the end face of the rectangular panel 40 to wipe the end-sealing material. As a result, the wiping work is similar to that shown in FIG. 4(b).

In addition, in order to reduce the height of the bleeding end-sealing material, the bleeding portion 50b of the end-sealing material 50 may be troweled over the end face of the rectangular panel 40 instead of removing at least a part of the bleeding portion 50b of the end-sealing material 50 as described above. In this troweling method, the end face of the rectangular panel 40 can be flattened in addition to the removal of excess end-sealing material. Also in this case, in place of the cotton cloth 70 shown in FIG. 4(b), a troweling jig such as a spatula may be placed on the end face of the rectangular panel 40 to trowel off the end-sealing material 50b.

The embodiment of the above treatments, i.e., the absorption, the wiping and the troweling-off can be practically implemented in an appropriately combined manner. For example, when the above cotton cloth 70 is moved along the end face of the rectangular panel 40 to wipe the end-sealing material, a portion of the end-sealing material is absorbed in the cotton cloth 70, another portion thereof is adhered to the surface of the cotton cloth 70 and removed, and the remaining portion is troweled off along the end face of the rectangular panel 40. In any mode of the treatments, the portion 50b of the end-sealing material 50 bleeding outside the contour of the rectangular panel 40 is unified, and the height thereof is reduced.

Also, even when the portion 50b of the end-sealing material 50 bleeds over a front side edge or a back side edge of the rectangular panel 40, the bleeding portion of the end-sealing material can be absorbed, wiped, or troweled off similarly to the method of treating the portion 50b bleeding over the end face of the rectangular panel 40 in the above embodiment.

Next, as shown in FIG. 3(d), the end-sealing material 50 is irradiated with the ultraviolet radiation and allowed to cure with the rectangular panel 40 compressed under the pressure Q, and the liquid crystal 42 is sealed in the liquid crystal sealing-in areas C (Step S24). A portion of the end-sealing material 50 injected inside the contour of the rectangular panel 40 including a portion 50a injected inside the liquid crystal injection ports 40a remains, and most of the portion 50b bleeding outside the contour of the rectangular panel 40 is removed by the above treatment. As a result, a portion of the end-sealing material 50 unnecessary for sealing the liquid crystal is removed, and a portion necessary for sealing the liquid crystal mainly remains, and the end-sealing material 50 can reliably cure in a short time.

As described above, the respective treatment steps of applying the end-sealing material, treating (removing) the bleeding portion, and curing the end-sealing material at a plurality of liquid crystal injection ports 40a of the rectangular panel 40 are completed, the treatment is advanced to the rectangular panel dividing step S6 shown in FIG. 6. This means that the rectangular panel 40 is divided into each liquid crystal sealing-in area C by a known scribe & break method, etc., and a plurality of liquid crystal panels having a single liquid crystal sealing-in area C are completed. A liquid crystal display as a completed product is obtained by bonding a polarizer and a reflector, mounting wiring members and semi-conductor devices, and building in a backlight and a case body.

In the above present embodiment, the spread of the bleeding portion 50b of the end-sealing material 50 (the volume of the end-sealing material), or the height of the bleeding portion 50b (projection from the contour of the panel) can be reduced by treating at least a part of the portion 50b bleeding outside the contour of the panel before the end-sealing material 50 cures. As a result, any troubles in the panel positioning, the panel assembly and other works in the manufacturing step can be removed without any troublesome works such as planing of the cured end-sealing material.

In particular, the spread or the height of the bleeding portion 50b of the uncured end-sealing material 50 can be easily reduced by the treatments including the absorption, the wiping, and the troweling-off and the working efficiency can be improved. Among these treatments, absorption of the end-sealing material by bringing an absorbent material into contact with the panel (pressing the absorbent material against the panel) is preferable in that a periphery of the panel can be prevented from being stained with the end-sealing material, and the stress exerted in a panel structure can be reduced. The method of absorbing the bleeding portion of the end-sealing material making use of the suction syringe or the like is efficient since a large volume of the end-sealing material can be drawn in one single absorbing operation when the bleeding volume is large.

In order to achieve the efficient suction for a large number of panels, the continuous suction is effective by the mechanical evacuation using a vacuum tube or the like in place of a manual suction syringe shown in FIG. 5.

In addition, in the conventional method, there are dangers of large stresses in and damages in the panel when planing the cured end-sealing material, and problems occur in that the shock resistance of the panel is degraded by the stresses and damages. However, in the present embodiment, neither large stresses nor damages occur after the end-sealing material cures, and degradation of the shock resistance of the liquid crystal panel can be prevented.

The above embodiment is described for a case in which ultraviolet radiation curing type resin is used for the end-sealing material. However, the end-sealing material is not limited thereto, and other materials such as a heat-curing-type resin can be used.

The manufacturing method of the liquid crystal display in accordance with the present invention is not limited to the above example shown in the figures, and various modification can be added to the scope so that they do not deviate from the object of the present invention.

As described above, excess end-sealing material can be removed by the methods of absorption, wiping, troweling-off, etc. after the end-sealing material such as the ultraviolet radiation curing resin is applied and before it cures, and excess end-sealing material can be easily removed without any loads or damages on the liquid crystal panel itself, and troubles caused by the bleeding end-sealing material can be easily prevented. Further, it is unnecessary to plane any cured end-sealing material, and no stresses are exerted in and no damages are incurred to the liquid crystal panel, and degradation of the shock resistance of the panel can be prevented. The entire disclosures of Japanese Patent Application Nos. 2000-265594 filed Sep. 1, 2000 and 2001-236576 filed Aug. 3, 2001 are incorporated herein by reference.

What is claimed is:

1. A manufacturing method of a liquid crystal display having a liquid crystal panel with a liquid crystal sealed in liquid crystal sealing-in areas disposed between a pair of substrates comprising the steps of:
a liquid crystal injecting step of injecting a liquid crystal from a liquid crystal injection port into said liquid crystal sealing-in areas;
an end-sealing material applying step of applying an uncured end-sealing material to said liquid crystal injection port after injecting the liquid crystal;
an end-sealing material removing step of removing at least a part of said end-sealing material bleeding outside a contour of said liquid crystal panel; and
an end-sealing material curing step of curing said end-sealing material after said end-sealing material removing step.

2. A manufacturing method of a liquid crystal display according to claim 1, wherein said end-sealing material removing step includes a step of absorbing said end-sealing material by bringing an absorbent material into contact with said end-sealing material, and absorbing said end-sealing material by said absorbent material.

3. A manufacturing method of a liquid crystal display according to claim 1, wherein said end-sealing material removing step includes a step of sucking said end-sealing material by bringing a suction jig into contact with said end-sealing material, and sucking said end-sealing material into said suction jig.

4. A manufacturing method of a liquid crystal display according to claim 3, wherein said end-sealing material removing step further includes a step of troweling off said end-sealing material along an end face of said liquid crystal panel where said liquid crystal injection port is arranged by a troweling jig after sucking said end-sealing material by said suction jig.

5. A manufacturing method of a liquid crystal display according to claim 1, further comprising:
a step of increasing a pressure inside said liquid crystal sealing-in areas of said liquid crystal panel before said liquid crystal injecting step; and
a step of evacuating said liquid crystal sealing-in areas after said end-sealing material applying step and before said end-sealing material removing step.

6. A manufacturing method of a liquid crystal display having a liquid crystal panel with a liquid crystal sealed in liquid crystal sealing-in areas disposed between a pair of substrates comprising the steps of:
a liquid crystal injecting step of injecting a liquid crystal from a liquid crystal injection port into said liquid crystal sealing-in areas;
an end-sealing material applying step of applying an uncured end-sealing material to said liquid crystal injection port after injecting the liquid crystal;
a wiping step of wiping at least a part of said end-sealing material bleeding outside the contour of said liquid crystal panel by a wiping jig; and
an end-sealing material curing step of curing said end-sealing material after said wiping step.

7. A manufacturing method of a liquid crystal display according to claim 6, further comprising:
a step of increasing a pressure inside said liquid crystal sealing-in areas of said liquid crystal panel before said liquid crystal injecting step; and
a step of evacuating said liquid crystal sealing-in areas after said end-sealing material applying step and before said end-sealing material wiping step.

8. A manufacturing method of a liquid crystal display having a liquid crystal panel with a liquid crystal sealed in liquid crystal sealing-in areas disposed between a pair of substrates comprising the steps of:
a liquid crystal injecting step of injecting the liquid crystal from a liquid crystal injection port into said liquid crystal sealing-in areas;
an end-sealing material applying step of applying an uncured end-sealing material to said liquid crystal injection port after injecting the liquid crystal;
a troweling step of troweling off the end-sealing material bleeding outside a contour of said liquid crystal panel along an end face of said liquid crystal panel where said liquid crystal injection port is arranged by a troweling jig; and
an end-sealing material curing step of curing said end-sealing material after said troweling step.

9. A manufacturing method of a liquid crystal display according to claim 8, further comprising:
a step of increasing a pressure inside said liquid crystal sealing-in areas of said liquid crystal panel before said liquid crystal injecting step; and
a step of evacuating said liquid crystal sealing-in areas after said end-sealing material applying step and before said end-sealing material troweling step.

10. A manufacturing method of a liquid crystal display having a liquid crystal panel with a liquid crystal sealed in liquid crystal sealing-in areas disposed between a pair of substrates,
wherein said liquid crystal panel is manufactured by injecting the liquid crystal from a liquid crystal injection port into said liquid crystal sealing-in areas, applying an uncured end-sealing material to said liquid crystal injection port after injecting the liquid crystal, sucking at least a part of said end-sealing material bleeding outside a contour of said liquid crystal panel, and curing said end-sealing material.

11. A manufacturing method of a liquid crystal display having a liquid crystal panel with a liquid crystal sealed in liquid crystal sealing-in areas disposed between a pair of substrates,
wherein said liquid crystal panel is manufactured by injecting the liquid crystal from a liquid crystal injection port into said liquid crystal sealing-in areas, applying an uncured end-sealing material to said liquid crystal injection port after injecting the liquid crystal, wiping at least a part of said end-sealing material bleeding outside a contour of said liquid crystal panel by a wiping jig, and curing said end-sealing material.

12. A manufacturing method of a liquid crystal display having a liquid crystal panel with a liquid crystal sealed in liquid crystal sealing-in areas disposed between a pair of substrates,
wherein said liquid crystal panel is manufactured by injecting the liquid crystal from a liquid crystal injection port into said liquid crystal sealing-in areas, applying an uncured end-sealing material to said liquid crystal injection port after injecting the liquid crystal, troweling off said end-sealing material bleeding outside a contour of said liquid crystal panel along an end face of said liquid crystal panel where said liquid crystal injection port is arranged by a troweling jig, and curing said end-sealing material.
